(19) United States
(12) Patent Application Publication
(10) Pub. No.: US 2015/0095769 A1
(43) Pub. Date: Apr. 2, 2015

(54) Layout Analysis Method And System

(71) Applicants: FOUNDER APABI TECHNOLOGY LIMITED, Beijing (CN); PEKING UNIVERSITY FOUNDER GROUP CO., LTD., Beijing (CN)

(72) Inventors: Jun Zhang, Beijing (CN); Ning Dong, Beijing (CN); Changsheng Wang, Beijing (CN)

(73) Assignees: FOUNDER APABI TECHNOLOGY LIMITED, Beijing (CN); PEKING UNIVERSITY FOUNDER GROUP CO., LTD., Beijing (CN)

(21) Appl. No.: 14/097,898

(22) Filed: Dec. 5, 2013

(30) Foreign Application Priority Data
Sep. 27, 2013 (CN) 201310452440.6

(51) Int. Cl. G06F 17/24; G06F 17/21

(52) U.S. Cl. CPC G06F 17/24; G06F 17/211
USPC 715/243

(57) ABSTRACT

Embodiments of the present invention provide a layout analysis method, comprising: extraction, collection of basic elements with respect to static area objects, analysis sequence determination and logical paragraph analysis, wherein the logical paragraph analysis comprises character analyzing, logical connection edge generating, line forming analyzing, paragraph forming analyzing, paragraph result filtering, basic elements collecting with respect to the dynamic area objects and basic element removing. According to the embodiments of the present invention, logical reference information and basic element data information are combined, and the logical reference information is fully used during layout analysis, such that a more accurate layout analysis result with respect to a fixed-layout document is acquired, and the layout analysis result is effectively improved.

### CROSS-REFERENCE TO RELATED APPLICATIONS/INCORPORATION BY REFERENCE

This patent application makes reference to, claims priority to, and claims benefit from Chinese Patent Application No. 201310452440.6 which was filed on Sep. 27, 2013 with the Chinese Patent Office.

Chinese Patent Application No. 201310452440.6 filed on Sep. 27, 2013, with the Chinese Patent Office, is hereby incorporated herein by reference in its entirety.

### FIELD OF THE INVENTION

Embodiments of the present invention relate to the field of information processing and mode recognition technologies, and in particular to a layout analysis method and system.

### BACKGROUND OF THE INVENTION

Fixed-layout document format is a fixed electronic document format for presenting a layout effect. The presentation of a fixed-layout document is independent of devices. In cases of reading, printing, or impressing over various devices, the presentation effect of the layout of the file is consistent. The fixed-layout document is mainly applied in publishing, propagation, and storage after the document has been completed. The fixed-layout document features fixed layout, and no layout shift, i.e., what you see is what you get (WYSIWYG), such that during operation of an electronic document, the presentation effect does not vary due to software, hardware and/or operators, and the layout, fixed-layout, font, and font size are completely the same as the paper document. Because of such features, the fixed-layout document has become an ideal document format for electronic file publishing, digitalized information propagation, and file storage. Fixed-layout documents are being gradually applied in more and more e-libraries, product manuals, corporation files, Internet-shared materials, and e-mails. Outside China, Adobe's PDF document format has become a well-recognized industry standard in the field of digitalized information.

With development of computer technologies and wide application of electronic reader devices, the number of fixed-layout documents is significantly growing. At present, more and more types of electronic reader devices are available, for example, e-books, PDAs, smart phones, and the like. Users desire to conveniently read files and documents in various devices. However, since common fixed-layout documents are subject to a fixed display mode, which is unfavorable to overall display on screens of different sizes, it is required that the content of the fixed-layout documents be re-typeset according to the sizes of the display devices. In addition, since in a fixed-layout document, the position and size of each document are accurately defined by using absolute values, such that the document is unfavorable to editing. Each time when the content of the document is modified, the layout of the document needs to be re-calculated, and the layout information needs to be re-written. Therefore, such edit operations as content search, structuralized storage, modifications, and extractions with respect to the fixed-layout document are troublesome.

Contents of a fixed-layout document may be categorized into texts, tables, images, graphs, separators, and the like. An area containing the same type of content is referred to as a homogeneous area. Layout analysis refers to a method of segmenting the homogeneous area in the document and annotating the segments, which is a primary step for document content analysis. After the analysis of the contents of the document, various homogenous areas are respectively processed. This greatly improves operability of modifying and editing the fixed-layout document. During layout analysis by using a conventional layout analysis method for a fixed-layout document, data information such as basic elements comprising characters, images, graphs, and the like are acquired from the fixed-layout document by using a fixed-layout document engine. Through the layout analysis on the fixed-layout document, a mapping relationship between fixed-layout document information and stream document information is established, such that such operations as editing, typesetting, modifying, and extraction may be better implemented. However, the layout analysis in the prior arts is performed based on the basic elements which are acquired by using the fixed-layout document engine, the layout analysis method is a single process, and the content that fails to be better recognized may not be further improved.

### SUMMARY OF THE INVENTION

In view of the defect that the layout analysis method in the prior arts is single, embodiments of the present invention provide a layout analysis method that is capable of integrating logical structure information into a conventional layout analysis method and thus effectively improving an analysis result of a fixed-layout document.

Accordingly, embodiments of the present invention provide a logical reference information-based layout analysis method.

An embodiment of the present invention provides a layout analysis method, comprising:

Acquiring, by an electronic device, logical paragraph information of a fixed-layout document, and acquiring basic element data on a current page as basic element data to be analyzed, wherein logical reference information of each logical paragraph comprises, arranged in a logical sequence, character objects, dynamic area objects and static area objects; and

collecting basic elements with respect to the static area objects, collecting basic elements with respect to the character objects based on character analysis, line forming analysis, paragraph forming analysis, and paragraph result filtering, collecting basic elements with respect to the dynamic area objects, and completing basic element collection with respect to the basic element data to be analyzed.

According to the layout analysis method, the static area objects comprise reference information of an absolute position, a width and a height of the static area in the fixed-layout document, and the dynamic area objects only comprise reference information of a width and a height of the dynamic area.

According to the layout analysis method, the basic element data on the current page is acquired by using a fixed-layout document engine, and comprises character basic elements, image basic elements, and graph basic elements.

According to the layout analysis method, the process of collecting basic elements with respect to the static area objects comprises: collecting the basic elements with respect to the static area objects and removing basic element data pertaining to the static area objects from the basic element data to be analyzed.

According to the layout analysis method, the process of collecting basic elements with respect to the character objects based on character analysis, line forming analysis, paragraph forming analysis and paragraph result filtering, the process of collecting basic elements with respect to the dynamic area objects, and the process of completing basic element collection with respect to the basic element data to be analyzed are completed by using logical paragraph analysis.

According to the layout analysis method, during the logical paragraph analysis, an analysis sequence of each logical paragraph is determined and then each of the logical paragraphs is logically analyzed.

According to the layout analysis method, the process of analyzing each of the logical paragraphs comprises: analyzing characters and establishing a logical connection edge, performing line forming analysis and paragraph forming analysis with respect to the logical connection edge, acquiring a target paragraph utilizing matching, and collecting basic elements of the dynamic area objects.

According to the layout analysis method, the process of analyzing each of the logical paragraphs specifically comprises:

character analyzing: filtering all character basic elements on the current page to reserve character basic elements having an identical character code in a current logical paragraph as candidate character basic elements;

logical connection edge generating: according to a logical sequence relationship between respective two characters in the current logical paragraph, connecting, among the candidate character basic elements, character basic elements which are respectively identical with two connected characters in the current logical paragraph, to generate a logical connection edge;

line forming analyzing: performing filtering and cluster analysis on the logical connection edges to acquire final line unit information in the logical paragraph;

paragraph forming analyzing: performing cluster analysis on all final line units according to a layout physical position relationship and a matching degree of line logical text character strings and logical text character strings in a target logical paragraph, combining final line units clustered into the same category, and performing layout analysis and sequencing thereon to generate a paragraph unit;

paragraph result filtering: performing accurate matching and non-accurate matching for all candidate paragraph units acquired by analysis and for the target logical paragraph to acquire a target paragraph unit;

collecting basic elements with respect to the dynamic area objects: with respect to each of the dynamic area objects in the logical paragraph, extracting character basic elements before and after the dynamic area object from the target paragraph unit, estimating a collection area having an absolute position according to a normal layout rule and dynamic area object width and height information within a blank area between bounding boxes of the character basic elements before and after the dynamic area object, and collecting the basic elements constituting the dynamic area object in the collection area; and

basic element removing: upon completion of the analysis of the current logical paragraph, removing the basic elements collected from the current logical paragraph from the basic element data to be analyzed on the current page, and analyzing the next logical paragraph according to the analysis sequence of the logical paragraphs.

According to the layout analysis method, the analysis sequence of the logical paragraphs is determined according to criteria comprising: the number of characters in the logical paragraphs, wherein a logical paragraph having a larger number of characters has a higher priority; a cross-page type of the logical paragraphs, wherein a normal logical paragraph has a higher priority over a cross-page logical paragraph; and natural and logical order of the logical paragraphs.

According to the layout analysis method, during the logical connection edge generating, when, among the candidate character basic elements, the character basic elements which are respectively identical with two connected characters in the current logical paragraph are all connected, the logical connection edge connects the center of a bounding box of each of the two character basic elements.

According to the layout analysis method, information of the logical connection edge comprises a horizontal angle between the logical connection edge and a horizontal direction, a normalized length, and a font size proportion associated with the connected character basic elements.

According to the layout analysis method, during the logical connection edge generating, when characters at two ends of the logical connection edge in the logical paragraph is spaced apart by the dynamic area objects or the static area objects, the logical connection edge is identified as a cross-area object logical connection edge.

According to the layout analysis method, the line forming analysis comprises:

(1) first-level line forming analyzing:

filtering all logical connection edges to remove logical connection edges passing through bounding boxes of other character basic elements in the page;

filtering the remaining logical connection edges for the second time, comparing horizontal angles, normalized length of the remaining logical connection edges with thresholds, retaining logical connection edges satisfying threshold conditions, and deleting the logical connection edges not satisfying the threshold conditions;

clustering all retained logical connection edges to arrange logical connection edges having the same head or tail character basic elements into one category;

performing normal line character sequence analysis on all character basic elements connected by the logical connection edges in one category to determine a logical sequence of all the character basic elements, and acquiring a first-level line unit; and

generating a first-level line unit with respect to each of the character basic elements that are not connected by any logical connection edge;

(2) second-level line forming analyzing:

finding all logical connection edges connecting the first-level line units, wherein the connected logical connection edge connects a tail character basic element of one first-level line unit and a head character basic element of another first-level line unit;

filtering all found logical connection edges to remove logical connection edges passing through bounding boxes of other character basic elements in the page, and retaining cross-area object logical connection edges;

clustering all retained logical connection edges;

combining all first-level line units connected by the logical connection edges clustered into one category, to acquire a second-level line unit; and

generating a second-level line unit with respect to each of the first-level line units that are not connected by any logical connection edge;

(3) second-level line combining:

performing cluster analysis on all second-level line units again;

combining all second-level line units clustered into one category to generate a final line unit; and

generating a final line unit for each of uncombined second-level units; and

(4) removing of invalid lines:

checking whether a Chinese character exists in a neighborhood of before and after positions or top and bottom positions of a bounding box of each of the final line units, and if a Chinese character exists, removing the line unit.

According to the layout analysis method, during filtering the remaining logical connection edges for the second time in the first-level line forming analyzing, a cross-area object logical connection edge is retained when a normalized length of the cross-area object logical connection edge is close to a width or a height of an area normalization object spanned by the cross-area object connection edge.

According to the layout analysis method, during the second-level line forming analyzing, all the retained logical connection edges are clustered based on the following criteria:

whether two logical connection edges connect the same first-level line unit; and

whether a perpendicular overlap degree or a horizontal overlap degree of bounding boxes of two connected first-level line units is larger than an empirical threshold, and

whether a matching degree of a combined character string of two neighboring first-level line units with a logical paragraph character string is larger than an empirical threshold, wherein the matching degree is calculated by using the flexible matching algorithm in Chinese strings.

According to the layout analysis method, in the second-level line combining during the line forming analyzing, all the retained second-level line units are clustered again based on the following criteria:

whether a perpendicular overlap degree or a horizontal overlap degree of bounding boxes of two second-level line units is larger than an empirical threshold;

whether horizontal spacing or horizontal spacing between bounding boxes of two second-level line units is larger than 0;

whether font or font size difference used by two second-level line units satisfies requirements; and

whether a matching degree of a combined character string of two neighboring second-level line units with a logical paragraph character string is larger than a threshold, wherein the matching degree is calculated by using the flexible matching algorithm in Chinese strings.

According to the layout analysis method, during the paragraph forming analyzing, the cluster analysis is implemented based on the following criteria:

whether a distance between text lines falls within a threshold range, and is spaced apart by an image basic element;

whether a width difference between upper and lower lines or between before and after lines as well as border alignment of line head and tail satisfy a threshold requirement with respect to a typical fixed-layout;

with respect to text lines satisfying the threshold requirement, whether a matching degree of a combined character string of two final line units with a logical paragraph character string satisfies a requirement is detected by using a flexible threshold; and

with respect to text lines not satisfying the threshold requirement, whether a matching degree of a combined character string of two final line units with a logical paragraph character string satisfies a requirement is detected by using a rigorous threshold.

According to the layout analysis method, the paragraph result filtering comprises:

(1) performing, according to a sequence, accurate matching and non-accurate matching for all paragraph units and the logical paragraphs, and returning a first matching result, wherein the accurate matching and the non-accurate matching are as follows:

accurate matching: with respect to a normal paragraph, a paragraph unit analysis character string needs to accurately match a logical paragraph character string; with respect to a cross-page paragraph, the paragraph unit analysis character string needs to accurately match a sub-string of the logical paragraph character string, and a bounding box of a logical paragraph is at a start or end physical position on the layout;

non-accurate matching: with respect to a normal paragraph, a matching degree, calculated by using the flexible matching algorithm in Chinese strings, of the paragraph unit analysis character string with the logical paragraph character string is larger than an empirical threshold; with respect to a cross-page paragraph, a matching degree, calculated by using the flexible matching algorithm in Chinese strings, of the paragraph unit analysis character string with a sub-string of the logical paragraph character string is larger than an empirical threshold, and a bounding box of a paragraph unit is at a start or end physical position on the layout;

(2) using a matched paragraph unit returned after the accurate matching or the non-accurate matching as the target paragraph unit, wherein if matched paragraph units are returned after both the accurate matching and the non-accurate matching, when a length of an analysis character string of the matched paragraph unit returned after the non-accurate matching is larger than a length of an analysis character string of the matched paragraph unit returned after the accurate matching, and the difference exceeds an empirical threshold, using the matched paragraph unit returned after the non-accurate matching as the target paragraph unit, and otherwise, using the matched paragraph unit returned after the accurate matching as the target paragraph unit; and

(3) performing character matching for the target paragraph unit and the logical paragraph by using the flexible matching algorithm in Chinese strings, and removing unmatched character basic elements in the target paragraph.

According to the layout analysis method, collecting the basic elements with respect to the static area objects comprises image collection, table collection, graph collection, formula collection, and an image collection policy, a table collection policy, a graph collection policy, and a formula collection policy are employed therefor respectively.

Another embodiment of the present invention provides a layout analysis system, comprising:

an acquiring unit, configured to: acquire logical paragraph information of a fixed-layout document, and acquire basic element data on a current page as basic element data to be analyzed, wherein logical reference information of each logical paragraph comprises, arranged in a logical sequence, character objects, dynamic area objects and static area objects; and

a collecting unit, configured to: collect basic elements with respect to the static area objects; collect basic elements with respect to the character objects based on character analysis, line forming analysis, paragraph forming analysis, and paragraph result filtering; collect basic elements with respect to the dynamic area objects; and complete basic element collection with respect to the basic element data to be analyzed.

The static area objects comprise reference information of an absolute position, a width and a height of the static area in the fixed-layout document, and the dynamic area objects only comprise reference information of a width and a height of the dynamic area.

The basic element data on the current page is acquired by using a fixed-layout document engine, and comprises character basic elements, image basic elements, and graph basic elements.

The process of collecting, by the collecting unit, basic elements with respect to the static area objects comprises: collecting the basic elements with respect to the static area objects and removing basic element data pertaining to the static area objects from the basic element data to be analyzed.

The collecting unit may comprise a logical paragraph analyzing unit, configured to complete the process of collecting basic elements with respect to the static area objects. The process of collecting basic elements with respect to the character objects based on character analysis, line forming analysis, paragraph forming analysis, and paragraph result filtering, the process of collecting basic elements with respect to the dynamic area objects, and the process of completing basic element collection with respect to the basic element data to be analyzed are completed using logical paragraph analysis.

During the logical paragraph analysis, the logical paragraph analyzing unit determines an analysis sequence of each logical paragraph and then logically analyzes each of the logical paragraphs.

The process of analyzing, by the logical paragraph analyzing unit, each of the logical paragraphs comprises: analyzing characters and establishing a logical connection edge, performing line forming analysis and paragraph forming analysis with respect to the logical connection edge, acquiring a target paragraph utilizing matching, and collecting basic elements of the dynamic area objects.

The logical paragraph analyzing unit may comprise:

a character analyzing unit, configured to filter all character basic elements on the current page to reserve character basic elements having the identical character code in a current logical paragraph as candidate character basic elements;

a logical connection edge generating unit, configured to: according to a logical sequence relationship between respectively two characters in the current logical paragraph, connect, among the candidate character basic elements, all character basic elements which are respectively identical with two connected characters in the current logical paragraph, to generate a logical connection edge;

a line forming analyzing unit, configured to perform filtering and cluster analysis on the logical connection edges to acquire final line unit information in the logical paragraph;

a paragraph forming analyzing unit, configured to: perform cluster analysis on all final line units according to layout physical position relationship and a matching degree of line logical text character strings and logical text character strings in a target logical paragraph; combine final line units clustered into the same category; and perform layout analysis and sequencing thereon to generate a paragraph unit;

a paragraph result filtering unit, configured to perform accurate matching and non-accurate matching for all candidate paragraph units acquired by analysis and for the target logical paragraph to acquire a target paragraph unit;

a dynamic area object basic element collecting unit, configured to: with respect to each of the dynamic area objects in the logical paragraph, extract character basic elements before and after the dynamic area object from the target paragraph unit, estimate a collection area having an absolute position according to a normal layout rule and dynamic area object width and height information within a blank area between bounding boxes of the character basic elements before and after the dynamic area object, and collect the basic elements constituting the dynamic area object in the collection area;

a removing unit, configured to: upon completion of the analysis of the current logical paragraph, remove the basic elements collected from the current logical paragraph from the basic element data to be analyzed on the current page, and analyze the next logical paragraph according to the analysis sequence of the logical paragraphs.

The logical paragraph analyzing unit determines the analysis sequence of the logical paragraphs according to criteria comprising: the number of characters in the logical paragraphs, wherein a logical paragraph having a larger number of characters has a higher priority; a cross-page type of the logical paragraphs, wherein a normal logical paragraph has a higher priority over a cross-page logical paragraph; and natural and logical order of the logical paragraphs.

When the logical connection edge generating unit connects, among the candidate character basic elements, all the character basic elements which are respectively identical with two connected characters in the current logical paragraph, the logical connection edge connects the center of a bounding box of each of the two character basic elements.

Information of the logical connection edge comprises a horizontal angle between the logical connection edge and a horizontal direction, a normalized length, and a font size proportion associated with the connected character basic elements.

When characters at two ends of the logical connection edge in the logical paragraph are spaced apart by the dynamic area objects or the static area objects, the logical connection edge is identified as a cross-area object logical connection edge.

The line forming analyzing unit is configured to perform operations comprising:

(1) first-level line forming analyzing:

filtering all logical connection edges to remove logical connection edges passing through bounding boxes of other character basic elements in the page;

filtering remaining logical connection edges for the second time, comparing horizontal angles, normalized length of the remaining logical connection edges with thresholds, retaining logical connection edges satisfying threshold conditions, and deleting the logical connection edges not satisfying the threshold conditions;

clustering all retained logical connection edges to arrange logical connection edges having the same head or tail character basic elements into one category;

performing normal line character sequence analysis on all character basic elements connected by the logical connection edges in one category to determine a logical sequence of all the character basic elements, and acquiring a first-level line unit; and

generating a first-level line unit with respect to each of the character basic elements that are not connected by any logical connection edge;

(2) second-level line forming analyzing:

finding all logical connection edges connecting the first-level line units, wherein the connected logical connection edge connects a tail character basic element of one first-level line unit and a head character basic element of another first-level line unit;

filtering all found logical connection edges to remove logical connection edges passing through bounding boxes of other character basic elements in the page, and retaining cross-area object logical connection edges;

clustering all retained logical connection edges;

combining all first-level line units connected by the logical connection edges clustered into one category, to acquire a second-level line unit; and

generating a second-level line unit with respect to each of the first-level line units that are not connected by any logical connection edge;

(3) second-level line combining:

performing cluster analysis on all second-level line units again;

combining all second-level line units clustered into one category to generate a final line unit; and

generating a final line unit for each of uncombined second-level units; and

(4) removing of invalid lines:

checking whether a Chinese character exists in a neighborhood of before and after positions or top and bottom positions of a bounding box of each of the final line units, and if a Chinese character exists, removing the line unit.

During filtering the remaining logical connection edges for the second time in the first-level line forming analyzing, a cross-area object logical connection edge is retained when a normalized length of the cross-area object logical connection edge is close to a width or a height of an area normalization object spanned by the cross-area object logical connection edge.

According to the layout analysis system, during the second-level line forming analysis, all the retained logical connection edges are clustered based on the following criteria:

whether two logical connection edges connect the same first-level line unit; and

whether a perpendicular overlap degree or a horizontal overlap degree of bounding boxes of two connected first-level line units is larger than an empirical threshold, and

whether a matching degree of a combined character string of two neighboring first-level line units with a logical paragraph character string is larger than an empirical threshold, wherein the matching degree is calculated by using a flexible matching algorithm in Chinese strings.

According to the layout analysis system, in the second-level line combining during the line forming analyzing, all the retained second-level line units are clustered again based on the following criteria:

whether a perpendicular overlap degree or a horizontal overlap degree of bounding boxes of two second-level line units is larger than an empirical threshold;

whether horizontal spacing or horizontal spacing between bounding boxes of two second-level line units is larger than 0;

whether font or font size difference used by two second-level line units satisfies requirements; and

whether a matching degree of a combined character string of two neighboring second-level line units with a logical paragraph character string is larger than a threshold, wherein the matching degree is calculated by using the flexible matching algorithm in Chinese strings.

According to the layout analysis system, during the paragraph forming analysis, the cluster analyzing is implemented based on the following criteria:

whether a distance between text lines falls within a threshold range, and is spaced apart by an image basic element;

whether a width difference between upper and lower lines or between before and after lines as well as border alignment of line head and tail satisfy a threshold requirement with respect to a typical fixed-layout;

with respect to text lines satisfying the threshold requirement, whether a matching degree of a combined character string of two final line units with a logical paragraph character string satisfies a requirement is detected by using a flexible threshold; and

with respect to text lines not satisfying the threshold requirement, whether a matching degree of a combined character string of two final line units with a logical paragraph character string satisfies a requirement is detected by using a rigorous threshold.

The paragraph result filtering unit performs operations comprising:

(1) performing, according to a sequence, accurate matching and non-accurate matching for all paragraph units and the logical paragraphs, and returning a first matching result, wherein the accurate matching and the non-accurate matching are as follows:

accurate matching: with respect to a normal paragraph, a paragraph unit analysis character string needs to accurately match a logical paragraph character string; with respect to a cross-page paragraph, the paragraph unit analysis character string needs to accurately match a sub-string of the logical paragraph character string, and a bounding box of a logical paragraph is at a start or end physical position on the layout;

non-accurate matching: with respect to a normal paragraph, a matching degree, calculated by using the flexible matching algorithm in Chinese strings, of the paragraph unit analysis character string with the logical paragraph character string is larger than an empirical threshold; with respect to a cross-page paragraph, a matching degree, calculated by using the flexible matching algorithm in Chinese strings, of the paragraph unit analysis character string with a sub-string of the logical paragraph character string is larger than an empirical threshold, and a bounding box of a paragraph unit is at a start or end physical position on the layout;

(2) using a matched paragraph unit returned after the accurate matching or the non-accurate matching as the target paragraph unit, wherein if matched paragraph units are returned after both the accurate matching and the non-accurate matching, when a length of an analysis character string of the matched paragraph unit returned after the non-accurate matching is larger than a length of an analysis character string of the matched paragraph unit returned after the accurate matching, and the difference exceeds an empirical threshold, using the matched paragraph unit returned after the non-accurate matching as the target paragraph unit, and otherwise, using the matched paragraph unit returned after the accurate matching as the target paragraph unit; and

(3) performing character matching for the target paragraph unit and the logical paragraph by using the flexible matching algorithm in Chinese strings, and removing unmatched character basic elements in the target paragraph.

The collecting basic elements collected by the collecting unit with respect to the static area objects comprises image collection, table collection, graph collection, formula collection, and an image collection policy, a table collection policy, a graph collection policy, and a formula collection policy are employed therefor respectively.

Compared with the prior arts, the technical solutions provided in the embodiments of the present invention achieve the following merits:

(1) The layout analysis method provided in the embodiments of the present invention comprises an extraction step and an analysis step, firstly logical paragraph information and basic element data are acquired; with respect to the different types of the logical reference information, basic elements are collected, by a combination of the logical reference information and the basic element data information, logical structure reference information acquired during digital file generation is also used as input data for the layout analysis, and basic analysis elements having the logical reference information are formed in combination of the basic element data. In addition, the logical reference information is fully used during the layout analysis, thereby acquiring the analysis result.

(2) According to the layout analysis method provided in the embodiments of the present invention, basic elements for the static area objects are collected and basic element data pertaining to the static area objects is removed from the basic element data to be analyzed; since the static area objects comprise reference information of an absolute position, a width, and a height of the static area in the fixed-layout document, basic element data pertaining to the static area objects may be collected by using a basic element collection policy with respect to the static area objects. The data may be directly collected, with no need of any special processing. Since information of the static area objects is relatively reliable, the basic element data collected by using the position information thereof is also relatively reliable, with no need of subsequent analysis. Therefore, removing of the basic elements pertaining to the static area objects prevents the basic elements from causing interference to the subsequent analysis, and meanwhile reduces workload for the subsequent processing, causing no repeated workload.

(3) According to the layout analysis method provided in the embodiments of the present invention, during logical paragraph analysis, an analysis sequence is first determined, and logical paragraphs are analyzed based on a predetermined sequence, thereby improving processing efficiency. Since more characters means more information that may be referenced during the analysis, and compared with a cross-page paragraph having the same number of characters as a normal paragraph, basic elements of result characters of the normal paragraph are all on the current page, the sequencing is performed based on the above criteria.

(4) According to the layout analysis method provided in the present invention, the analyzing each of the logical paragraphs comprises: analyzing characters and establishing a logical connection edge, performing line forming analysis and paragraph forming analysis with respect to the logical connection edge, acquiring a target paragraph utilizing matching, and collecting basic elements of the dynamic area objects. Since the sequence of related characters reflects a logical relationship thereof, a target paragraph is finally acquired by line forming and paragraph forming analysis by using logical connection edges, and accuracy in collecting basic elements pertaining to character objects is improved.

### BRIEF DESCRIPTION OF THE DRAWINGS

For a better understanding of the disclosure in the embodiments of the present invention, the present invention is described in detail as follows with reference to specific embodiments and accompanying drawings.

FIG. 1 is a flowchart of a layout analysis method according to Embodiment 1 of the present invention.

FIG. 2 is a flowchart of a layout analysis method according to another embodiment of the present invention.

FIG. 3 is a flowchart of logical paragraph analysis in a layout analysis method according to an embodiment of the present invention.

FIG. 4 is a schematic diagram of collecting basic elements with respect to static area objects in a layout analysis method according to an embodiment of the present invention.

FIG. 5 is a schematic diagram of filtering characters in a layout analysis method according to an embodiment of the present invention.

FIG. 6 is a schematic diagram of generating a logical connection edge in a layout analysis method according to an embodiment of the present invention.

FIG. 7 is a schematic diagram of line forming analysis in a layout analysis method according to an embodiment of the present invention.

FIG. 8 is a schematic diagram of paragraph forming analysis in a layout analysis method according to an embodiment of the present invention.

FIG. 9 is a schematic diagram of collecting basic elements with respect to dynamic area objects in a layout analysis method according to an embodiment of the present invention.

### DETAILED DESCRIPTION OF THE PREFERRED EMBODIMENTS

### Embodiment 1

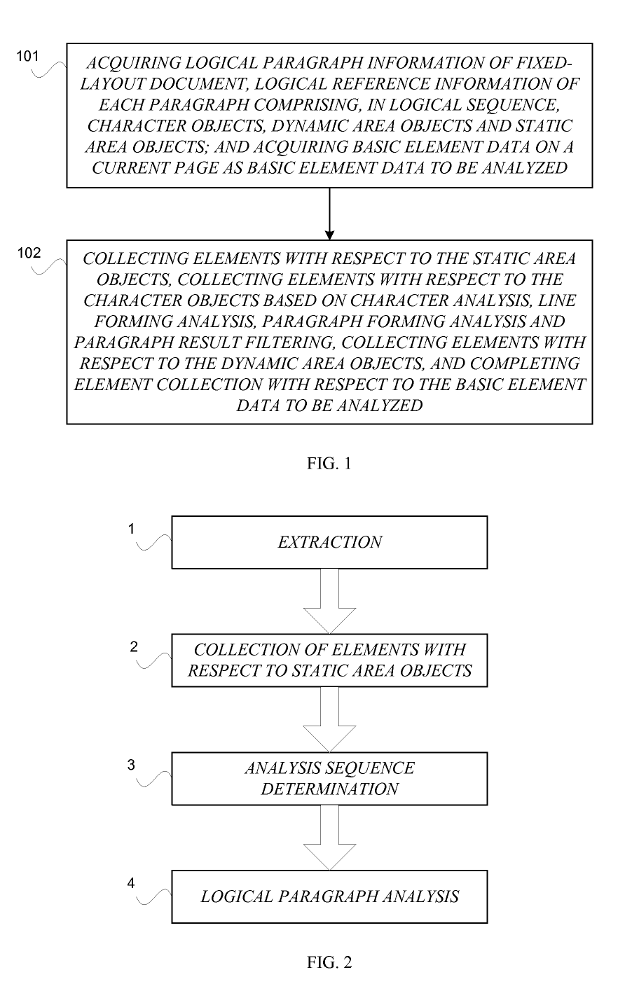

This embodiment provides a layout analysis method, as illustrated in FIG. 1, comprising:

acquiring logical paragraph information of a fixed-layout document, and acquiring basic element data on a current page as basic element data to be analyzed, wherein logical reference information of each logical paragraph comprises character objects, dynamic area objects and static area objects that are arranged in a logical sequence; and

collecting basic elements with respect to the static area objects, collecting basic elements with respect to the character objects based on character analysis, line forming analysis, paragraph forming analysis, and paragraph result filtering, collecting basic elements with respect to the dynamic area objects, and completing basic element collection with respect to the basic element data to be analyzed.

According to the layout analysis method, with respect to the different types of the logical reference information, basic elements are collected, by a combination of the logical reference information and the basic element data information, logical structure reference information acquired during digital document generation is also used as input data for the layout analysis, and basic analysis elements having the logical reference information are formed in combination of the basic element data. In addition, the logical reference information is fully used during the layout analysis, thereby acquiring the analysis result.

### Embodiment 2

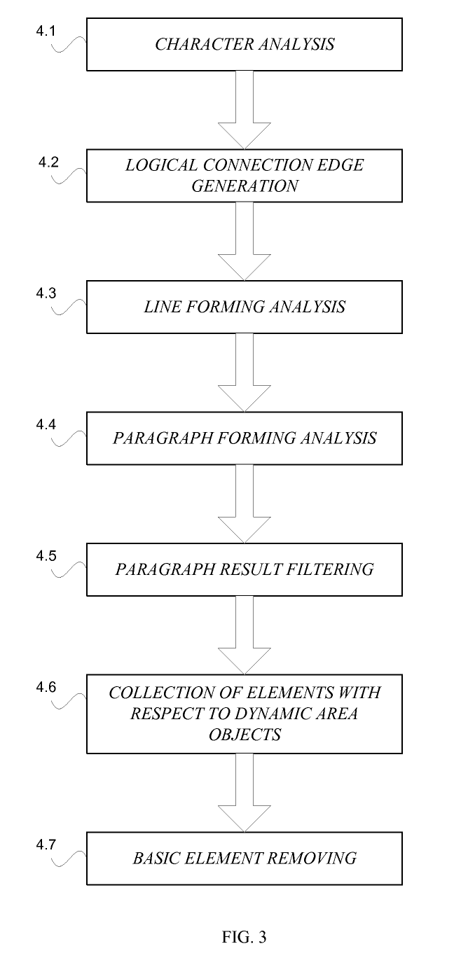

This embodiment provides a layout analysis method, as illustrated in FIGS. 2 and 3, comprising:

(1) Extracting: acquiring logical paragraphs in a fixed-layout document, wherein each of the logical paragraphs comprises character objects, dynamic area objects, and static area objects, acquiring, by using a fixed-layout document engine, basic element data on a current page as basic element data to be analyzed, wherein the basic element data comprises basic character elements, basic image elements, and basic graph elements. Prior to layout analysis, during previous fixed-layout document processing, all logical paragraph information of the document has been acquired, and all logical paragraphs are logically sequenced, which all pertain to logical information known before the layout analysis.

One page may comprise a type page box and a plurality of logical paragraphs, wherein the logical paragraphs are sequenced according to a natural and logical order. The type page box herein refers to an area of main content on a page, and the logical paragraphs comprise logical sequence information of characters and objects and are categorized into normal paragraphs and cross-page paragraphs. In a normal paragraph, all content of the paragraph is on the current page; whilst in a cross-page paragraph, a part of the content of the paragraph is on the current page. Each of the logical paragraphs comprises a plurality of characters and area objects, wherein the area objects are categorized into dynamic area objects and static area objects. The static area objects comprise reference information of an absolute position, a width and a height of the static area in the fixed-layout document, and the dynamic area objects comprise reference information of a width and a height of the dynamic area. The static area objects may be categorized, according to logical roles thereof, into images, tables, graphs, and formulas. The plurality of characters in the logical paragraph and the area objects are also sequenced according to the natural and logical order.

(2) Collecting basic elements with respect to static area objects: collecting static area objects, and removing basic element data pertaining to the static area objects from the basic element data to be analyzed.

Since the static area object in the logical reference information comprises the absolute position, the width, and the height of the static area in the fixed-layout document, that is, the target collection area is known, basic elements with respect to the area objects are collected first. With respect to each of the static area objects, all basic elements on the page are filtered by using a corresponding collection policy according to the logical type of the static area object, with basic elements satisfying the requirement of the collection policy retained. The retained basic elements are constituent basic elements of the static area object. Subsequently, the collected basic elements with respect to the static area objects are removed from the basic element data to be analyzed on the current page.

Since information of the static area objects is relatively reliable, the basic element data collected by using the position information thereof is also relatively reliable, with no need of subsequent analysis. Therefore, removing of the basic elements pertaining to the static area objects prevents the basic elements from causing interference to the subsequent analysis, and meanwhile reduces workload for the subsequent processing, causing no repeated workload.

(3) Analysis sequence determining: determining an analysis sequence of each of the logical paragraphs. The analysis sequence of the logical paragraphs is determined according to criteria comprising: \textcircled{1} a number of characters in the logical paragraphs, wherein a logical paragraph having a larger number of characters has a higher priority; \textcircled{2} a cross-page type of the logical paragraphs, wherein a normal logical paragraph has a higher priority over a cross-page logical paragraph; and \textcircled{3} a natural and logical order of the logical paragraphs.

Since more characters means more information that may be referenced during the analysis, and compared with a cross-page paragraph having the same number of characters as a normal paragraph, basic elements of result characters of the normal paragraph are all on the current page, the sequencing is performed based on the above criteria.

(4) Logical paragraph analyzing: the logical paragraph is analyzed as follows, as illustrated in FIG. 3.

(4.1) Character analyzing: filtering all character basic elements on the current page to reserve character basic elements having an identical character code in a current logical paragraph as candidate character basic elements.

(4.2) Logical connection edge generating: according to a logical sequence relationship between respective two characters in the current logical paragraph, connecting, among the candidate character basic elements, all character basic elements which are respectively identical with two connected characters in the current logical paragraph, to generate a logical connection edge. In this embodiment, the logical connection edge connects the center of the bounding box of two character basic elements. In an alternative embodiment, the logical connection edge may also connect another position of the bounding box. For example, if four logical character strings “ [symbol] ” (layout analysis) are present in a logical paragraph, logical connection edges may be generated between all character basic elements with the codes of “ [symbol] (layout)” and “ [symbol] (layout)” on the page, logical connection edges may also be generated between all character basic elements with the codes of “ [symbol] (layout)” and “ [symbol] (analysis)”, and analogously logical connection edges may be generated between all character basic elements with the codes of “ [symbol] (analysis)” and “ [symbol] (analysis)”.

(4.3) Line forming analyzing: performing filtering and cluster analysis on the logical connection edges to acquire final line unit information in the logical paragraph.

(4.4) Paragraph forming analyzing: performing cluster analysis on all final line units based on whether these units pertain to the same logical paragraph, combining final line units clustered into the same category, and performing layout analysis and sequencing thereon to generate a paragraph unit.

(4.5) Paragraph result filtering: performing, according to a sequence, accurate matching and non-accurate matching for all paragraph units and the logical paragraphs, to acquire a target paragraph unit.

(4.6) Collecting basic elements with respect to the dynamic area objects: with respect to each of the dynamic area objects in the logical paragraph, extracting character basic elements before and after the dynamic area object from the target paragraph unit, estimating a collection area having an absolute position according to a normal layout rule and dynamic area object width and height information within a blank area between bounding boxes of the character basic elements before and after the dynamic area object, and collecting the basic elements constituting the dynamic area object.

(4.7) Basic element removing: upon completion of the analysis of the current logical paragraph, removing the basic elements collected from the current logical paragraph from the basic element data to be analyzed on the current page, and analyzing a next logical paragraph according to the analysis sequence of the logical paragraphs.

### Embodiment 3

This embodiment provides a layout analysis method, comprising the following steps:

(1) Extracting, the same as that in Embodiment 1.

(2) Collecting basic elements with respect to static area objects, the same as that in Embodiment 1. In this embodiment, during filtering of all basic elements on the page with respect to each of the static area objects, the basic elements are collected by using the corresponding collection policy according to the logical type of the static area object. The specific policies comprise:

1) Image collection policy: only image basic elements are collected, and it is required that the bounding boxes of the image basic elements overlap with the target collection area, and a ratio of the area of an overlapping area to the area of the bounding boxes of the image basic elements be larger than an empirical threshold.

2) Table collection policy: basic elements of characters, graphs, and images are collected, and it is required that the bounding boxes of the basic elements be totally contained by the target collection area.

3) Graph collection policy: only graph basic elements are collected, and it is required that the bounding boxes of the basic elements be totally contained by the target collection area.

4) Formula collection policy: basic elements of characters and graphs are collected, and it is required that the bounding boxes of the basic elements overlap the target collection area.

As illustrated in FIG. 2, an example of collecting basic elements with respect to static area objects is given.

(3) Analysis sequence determining, the same as that in Embodiment 1.

(4) Logical paragraph analyzing. The logical paragraph is analyzed as follows:

(4.1) Character analyzing: filtering all character basic elements on the current page to reserve character basic elements having an identical character code in a current logical paragraph as candidate character basic elements.

(4.2) Logical connection edge generating, the same as that in Embodiment 1. After the logical connection edge is generated, information of the logical connection edge comprises a horizontal angle between connection edges, a normalized length, and a font size proportion associated with the connected character basic elements. Herein the normalized length is acquired by dividing a length of the logical connection edge by an average value of the sizes of the character basic elements before and after the dynamic area objects. During logical connection edge generating, when characters at two ends of the connection edge in the logical paragraph are spaced apart by the dynamic area objects or the static area objects, the logical connection edge is identified as a cross-area object logical connection edge.

(4.3) Line forming analyzing: performing filtering and cluster analysis on the logical connection edges to acquire final line unit information in the logical paragraph. The specific process may be as follows:

(4.3.1) First-level line forming analyzing:

1) Filtering all logical connection edges to remove logical connection edges of bounding boxes of other character basic elements passing through the page.

2) Secondarily filtering all the remaining logical connection edges, comparing horizontal angles, normalized length of the remaining logical connection edges with thresholds, retaining logical connection edges satisfying threshold conditions, and deleting the logical connection edges not satisfying the threshold conditions. To be specific, the secondary filtering is performed based on: comparison between the horizontal angle and normalized length of a logical connection edge with an empirical threshold, wherein a logical connection edge satisfying the threshold requirement is retained. With respect to logical connection edges of the cross-area objects, the criteria are: the logical connection edge of the cross-area object satisfies the requirement of the empirical threshold; with respect to a landscape-layout document, the logical connection edge is retained when the normalized length thereof is close to the width of an area normalization object; with respect to a portrait-layout document, the logical connection edge is retained when the normalized length thereof is close to the height of the area normalization object.

3) Clustering all retained logical connection edges to arrange logical connection edges having the same head or tail character basic elements into one category.

4) Performing normal line character sequence analysis on all character basic elements of the logical connection edges in one category to determine a logical sequence of all the character basic elements, and acquiring a first-level line unit.

5) Generating a first-level line unit with respect to each of the character basic elements that are not connected by any logical connection edge.

Through the above steps, character basic elements that are neighboring or adjacent on the layout are acquired to form a first-level line.

(4.3.2) Second-level line forming analyzing:

1) Finding all logical connection edges connecting the first-level line units, wherein the connected logical connection edge connects tail character basic elements of one first-level line unit and head character basic elements of another first-level line unit.

For example, assuming that a first-level line A is “ [symbol] (it may today)”, another first-level line B “ [symbol] (may rain)”, and a target character string is “ [symbol] (it may rain today)”, then a logical connection edge connects the tail “ [symbol] (may)” in the first-level line A with the head “ [symbol] (may)” in the first-level line B.

2) Filtering all found logical connection edges to remove logical connection edges of bounding boxes of other character basic elements passing through the page, and retaining logical connection edges of cross-area objects.

3) All retained logical connection edges are clustered based on the following criteria: a). whether two logical connection edges connect the same first-level line unit; b). with respect to a landscape-layout document, whether a perpendicular overlapping degree of bounding boxes of two connected first-level line units is larger than an empirical threshold; or with respect to a portrait-layout document, whether a horizontal overlapping degree of bounding boxes of two connected first-level line units is larger than an empirical threshold; and c). whether a matching degree of a combined character string of two neighboring first-level line units with a logical paragraph character string is larger than an empirical threshold, wherein the matching degree is calculated by using a flexible matching algorithm for Chinese strings.

4) Combining all first-level line units connected by the logical connection edges clustered into one category, to acquire a second-level line unit.

5) Generating a second-level line unit with respect to each of the first-level line units that are not connected by any logical connection edge.

Through the above steps, the first-level lines that are physically far on the layout but having the logical connection edges are combined.

(4.3.3) Second-level line combining:

1) All retained second-level line units are clustered based on the following criteria: a). with respect to a landscape-layout document, whether a perpendicular overlapping degree of bounding boxes of two second-level line units is larger than an empirical threshold; or with respect to a portrait-layout document, whether a horizontal overlapping degree of bounding boxes of two second-level line units is larger than an empirical threshold; b). with respect to a landscape-layout document, whether horizontal spacing between bounding boxes of two second-level line units is larger than 0; or with respect to a portrait-layout document, whether horizontal spacing between bounding boxes of two second-level line units is larger than 0; c). whether font or font size difference with respect to two second-level line units satisfies requirements; and d). whether a matching degree of a combined character string of two neighboring first-level line units with a logical paragraph character string is larger than an empirical threshold, wherein the matching degree is calculated by using the flexible character string matching algorithm. Through the above steps, with respect to second-level units, the similar font is used for characters in the same line in terms of the physical layout position, and the combined character strings are in the target paragraph text.

2) Combining all second-level line units clustered into one category to generate a final line unit.

3) Generating a final line unit for each of uncombined second-level units.

(4.3.4) Removing of invalid lines:

Checking whether a Chinese character exists in a neighborhood of before and after positions or top and bottom positions of a bounding box of each of the final line units, and if a Chinese character exists, removing the line unit; With respect to a landscape-layout document, it is checked whether a Chinese character exists in a neighborhood of before and after positions of a bounding box of each of the final line units; with respect to a portrait-layout document, it is checked whether a Chinese character exists in a neighborhood of top and bottom positions of a bounding box of each of the final line units. If a Chinese character exists, then the final line unit is embedded in a natural line on the actual layout, and needs to be filtered out.

(4.4) Paragraph forming analyzing: performing cluster analysis on all final line units based on whether these units pertain to the same logical paragraph, combining final line units clustered into the same category, and performing layout analysis and sequencing thereon to generate a paragraph unit.

The cluster analysis is based on the following criteria: whether a distance between text lines falls within a threshold range, and whether is spaced apart by an image basic element; whether a width difference between upper and lower lines or between before and after lines satisfies a threshold requirement with respect to a typical fixed-layout; with respect to text lines satisfying the threshold requirement, whether a matching degree of a combined character string of two final line units with a logical paragraph character string satisfies a requirement is detected by using a flexible threshold; and with respect to text lines not satisfying the threshold requirement, whether a matching degree of a combined character string of two final line units with a logical paragraph character string satisfies a requirement is detected by using a rigorous threshold. In this way, a plurality of lines may be further combined to acquire a paragraph unit.

To be specific, with respect to a landscape-layout document, the cluster analysis is based on the following criteria: whether a distance between upper and lower lines falls within a empirical threshold range, and whether is spaced apart by an image basic element; whether a width difference between upper and lower lines satisfies a threshold requirement with respect to a typical fixed-layout (center justification/indentation/suspension); with respect to upper and lower text lines (landscape-layout document) satisfying the threshold requirement, whether a matching degree of a combined character string of two final line units with a logical paragraph character string satisfies a requirement is detected by using a flexible threshold; and with respect to text lines not satisfying the threshold requirement, whether a matching degree of a combined character string of two final line units with a logical paragraph character string satisfies a requirement is detected by using a rigorous threshold.

To be specific, with respect to a portrait-layout document, the cluster analysis is based on the following criteria: whether a distance between before and after text lines falls within a empirical threshold range, and whether is spaced apart by an image basic element; whether a width difference between before and after lines satisfies a threshold requirement with respect to a typical fixed-layout (center justification/indentation/suspension); with respect to before and after text lines (portrait-layout document) satisfying the threshold requirement, whether a matching degree of a combined character string of two final line units with a logical paragraph character string satisfies a requirement is detected by using a flexible threshold; and with respect to before and after text lines not satisfying the threshold requirement, whether a matching degree of a combined character string of two final line units with a logical paragraph character string satisfies a requirement is detected by using a rigorous threshold.

(4.5) Paragraph result filtering: performing, according to a sequence, accurate matching and non-accurate matching for all paragraph units and the logical paragraphs to acquire a target paragraph unit. To be specific, all candidate paragraph units acquired are subject to match with the target logical paragraph, and the paragraph most matching the target logical paragraph is selected as a paragraph result. The specific process is as follows:

Firstly, sequencing all paragraph unit based on sequencing criteria comprising: a). number of characters in the paragraph units, wherein a logical paragraph having a larger number of characters has a higher priority; b). physical position of the logical paragraphs in the layout; Since there is a high probability that the logical paragraph having a largest number of character basic elements is the result logical paragraph, with respect to logical paragraphs having the same number of character basic elements, it may be estimated, according to the physical positions thereof, that the logical paragraphs have a higher priority. Therefore, the above sequencing manner is employed;

secondly, performing, according the acquired sequence, accurate matching and non-accurate matching for all paragraph units and the logical paragraphs, and returning a first matching result, wherein the accurate matching and the non-accurate matching are as follows:

accurate matching: with respect to a normal paragraph, a paragraph unit analysis character string needs to accurately match a logical paragraph character string, wherein a first-level line, a second-level line, and a paragraph are acquired during the analysis, corresponding lines and paragraph character strings are generated by using the character basic elements, and logical paragraph character strings are acquired according to known logical paragraph information; with respect to a cross-page paragraph, the paragraph unit analysis character string needs to accurately match a sub-string of the logical paragraph character string, and a bounding box of a paragraph unit is at a start or end physical position on the layout; for example, “ [symbol] (it may rain)” is a sub-character string of “ [symbol] [symbol] (it may rain tonight”;

non-accurate matching: with respect to a normal paragraph, a matching degree, calculated by using the flexible matching algorithm in Chinese strings, of the logical paragraph unit analysis character string with the logical paragraph character string is larger than an empirical threshold; with respect to a cross-page paragraph, a matching degree, calculated by using the flexible matching algorithm in Chinese strings, of the logical unit analysis character string with a sub-string of the logical paragraph character string is larger than an empirical threshold, and a bounding box of a paragraph unit is at a start or end physical position on the layout;

using a matched paragraph unit returned after the accurate matching or the non-accurate matching as the target paragraph unit, wherein if a matched paragraph unit is returned respectively after the accurate matching and the non-accurate matching, when a length of an analysis character string of the matched paragraph unit returned after the non-accurate matching is larger than a length of an analysis character string of the matched paragraph unit returned after the accurate matching, and exceeds an empirical threshold, using the matched paragraph unit returned after the non-accurate matching as the target paragraph unit, and otherwise, using the matched paragraph unit returned after the accurate matching as the target paragraph unit; wherein through the paragraph analysis, a plurality of paragraphs may be acquired; for example, after page analysis, four paragraphs “ [symbol] (it rains today)”, “ [symbol] [symbol] (it may rain later today)”, “ [symbol] [symbol] (it may rain tonight)”, and “ [symbol] it rains)” from “ [symbol] [symbol] (it may rain tonight)”, and the actually matched paragraph needs to be acquired therefrom; and

performing character matching for the target paragraph unit and the logical paragraph by using the flexible matching algorithm in Chinese strings, and removing unmatched character basic elements in the target paragraph; wherein since the paragraph analysis result may include extra characters, these characters need to be found by using a matching algorithm and then be removed.

The flexible pattern matching algorithm in Chinese strings is an approximate matching algorithm, which allows certain differences between two character strings, and is different from one-to-one corresponding accurate matching.

(4.6) Collecting basic elements with respect to dynamic area objects.

With respect to a dynamic area object in a paragraph, since reference information of a width and a height thereof is only known, an absolute position of the dynamic area object on the layout needs to be estimated according to before and after character basic elements.

With respect to each of the dynamic area objects in the logical paragraph, the character basic elements before and after the dynamic area object are extracted from the target paragraph, a collection area having an absolute position is estimated according to a normal layout rule and dynamic area object width and height information within a blank area between bounding boxes of the character basic elements before and after the dynamic area object, and the basic elements constituting the dynamic area object are collected. The basic element collection policy herein is the same as that employed with respect to the static area objects.

(4.7) Basic element removing: upon completion of the analysis of the current logical paragraph, removing the basic elements collected from the current logical paragraph from the basic element data to be analyzed on the current page, wherein these basic elements are not involved in analysis of the subsequent logical paragraphs; and analyzing a next logical paragraph according to the analysis sequence of the logical paragraphs.

### Embodiment 4

This embodiment provides a layout analysis system, comprising:

an acquiring unit, configured to: acquire logical paragraph information of a fixed-layout document, and acquire basic element data on a current page as basic element data to be analyzed, wherein logical reference information of each paragraph comprises character objects, dynamic area objects and static area objects that are arranged in a logical sequence; and

a collecting unit, configured to: collect basic elements with respect to the static area objects; collect basic elements with respect to the character objects after character analysis, line forming analysis, paragraph forming analysis and paragraph result filtering; collect basic elements with respect to the dynamic area objects; and complete basic element collection with respect to the basic element data to be analyzed.

The static area objects comprise reference information of an absolute position, a width and a height of the static area in the fixed-layout document, and the dynamic area objects comprise reference information of a width and a height of the dynamic area.

The basic element data on the current page is acquired by using a fixed-layout document engine, and comprises basic character elements, basic image elements and basic graph elements.

The collecting basic elements with respect to the static area objects comprises: collecting the basic elements with respect to the static area objects and removing basic element data pertaining to the static area objects from the basic element data to be analyzed.

The process of collecting basic elements with respect to the static area objects, collecting basic elements with respect to the character objects after character analysis, line forming analysis, paragraph forming analysis and paragraph result filtering, collecting basic elements with respect to the dynamic area objects, and completing basic element collection with respect to the basic element data to be analyzed is completed by using logical paragraph analysis.

During the logical paragraph analysis, an analysis sequence logical paragraphs is determined and then each of the logical paragraphs is logically analyzed.

The analyzing each of the logical paragraphs comprises: analyzing characters and establishing a logical connection edge, performing line forming analysis and paragraph forming analysis with respect to the logical connection edge, acquiring a target paragraph utilizing matching, and collecting basic elements of the dynamic area objects.

The logical paragraph analyzing unit may comprise:

a character analyzing unit, configured to filter all character basic elements on the current page to reserve character basic elements having the identical character code in a current logical paragraph as candidate character basic elements;

a logical connection edge generating unit, configured to: according to a logical sequence relationship between respective two characters in the current logical paragraph, connect, among the candidate character basic elements, all character basic elements which are respectively identical with two connected characters in the current logical paragraph, to generate a logical connection edge;

a line forming analysis unit, configured to perform filtering and cluster analysis on the logical connection edges to acquire final line unit information in the logical paragraph;

a paragraph forming analyzing unit, configured to: perform cluster analysis on all final line units according to a layout physical position relationship and a matching degree of line logical text character strings and logical text character strings in a target logical paragraph; combine final line units clustered into the same category; and perform layout analysis and sequencing thereon to generate a paragraph unit;

a paragraph result filtering unit, configured to perform accurate matching and non-accurate matching for all candidate paragraph units acquired by analysis and the target logical paragraph to acquire a target paragraph unit;

a dynamic area object basic element collecting unit, configured to: with respect to each of the dynamic area objects in the logical paragraph, extract the character basic elements before and after the dynamic area object from the target paragraph unit, estimate a collection area having an absolute position according to a normal layout rule and dynamic area object width and height information within a blank area between bounding boxes of the character basic elements before and after the dynamic area object, and collect the basic elements constituting the dynamic area object;

a removing unit, configured to: upon completion of the analysis of the current logical paragraph, remove the basic elements collected from the current logical paragraph from the basic element data to be analyzed on the current page, and analyze a next logical paragraph according to the analysis sequence of the logical paragraphs.

### Embodiment 5

An application example of the present invention is given below, and detailed description is given by analyzing a sample page in a sample Chinese document.

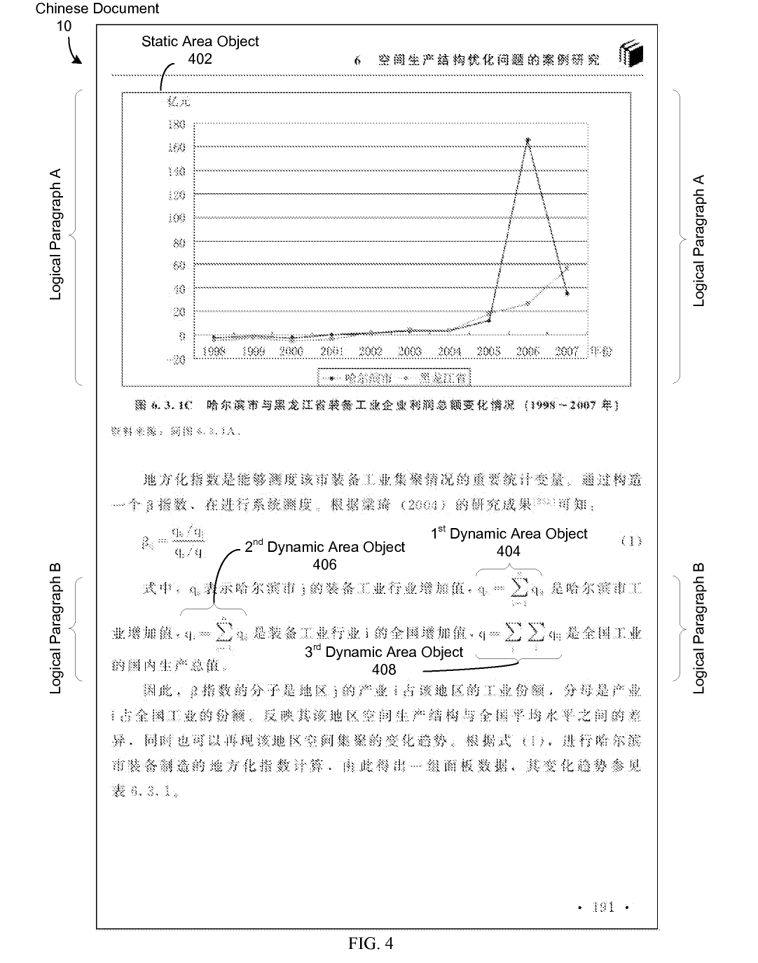

Referring to FIGS. 4-9, two typical logical paragraphs in the samples are given, wherein:

Logical paragraph A: “[static area basic element IMG]”

Logical paragraph B: “in the formula, qᵢⱼ denotes the industrial added value in the equipment sector in Haerbin City j, [dynamic area basic element FORMULA] denotes the industrial added value in Haerbin City, [dynamic area basic element FORMULA] denotes the national industrial added value in the equipment sector i, and [dynamic area basic element FORMULA] denotes the national GDP in the industry sector.”

The layout analysis method employed for this example comprises:

(1) Extracting: extracting logical paragraphs in a fixed-layout document, wherein each of the logical paragraphs comprises character objects, dynamic area objects, and static area objects, acquiring, by using a fixed-layout document engine, basic element data on a current page as basic element data to be analyzed, wherein the basic element data comprises basic character elements, basic image elements, and basic graph elements.

(2) Collecting basic elements with respect to static area objects: collecting static area objects, and removing basic element data pertaining to the static area objects from the basic element data to be analyzed. The logical paragraph A is formed of a static area object (image). Therefore, in this step, corresponding image basic elements within the target collection area may be acquired by using the image collection policy, as illustrated in FIG. 4.

(3) Analysis sequence determining: determining an analysis sequence of each of the logical paragraphs.

(4) Logical paragraph analyzing. The logical paragraph is analyzed as follows:

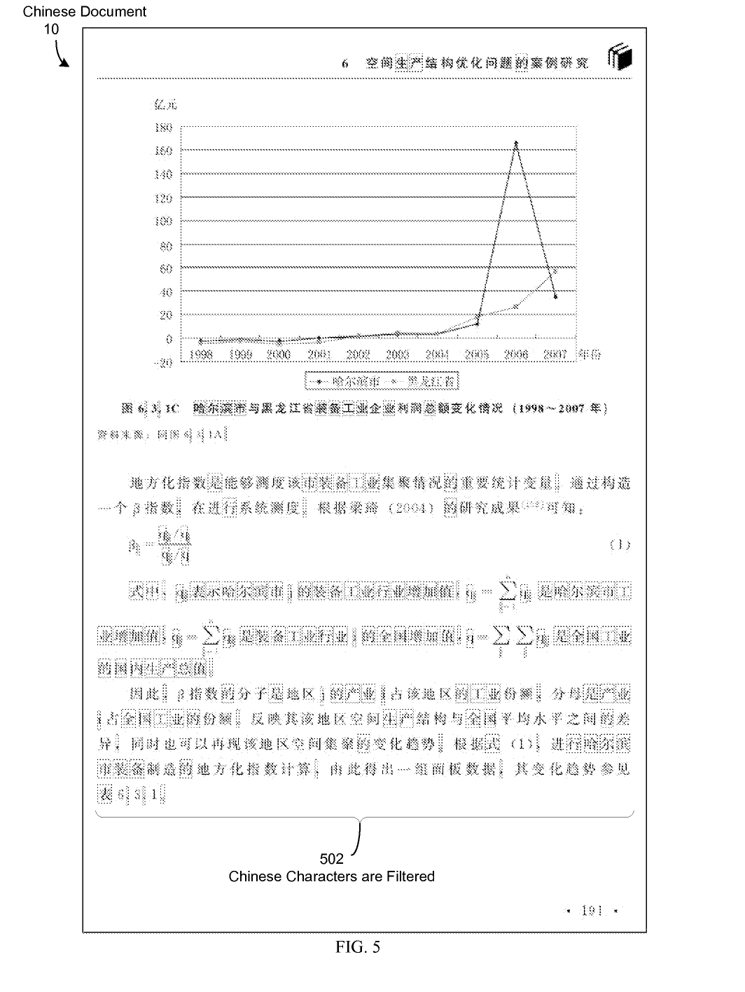

(4.1) Character analyzing: the logical paragraph B is formed of a plurality of characters and three dynamic area objects (formulas), and characters are filtered in this step, as illustrated in FIG. 5.

(4.2) Logical connection edge generating

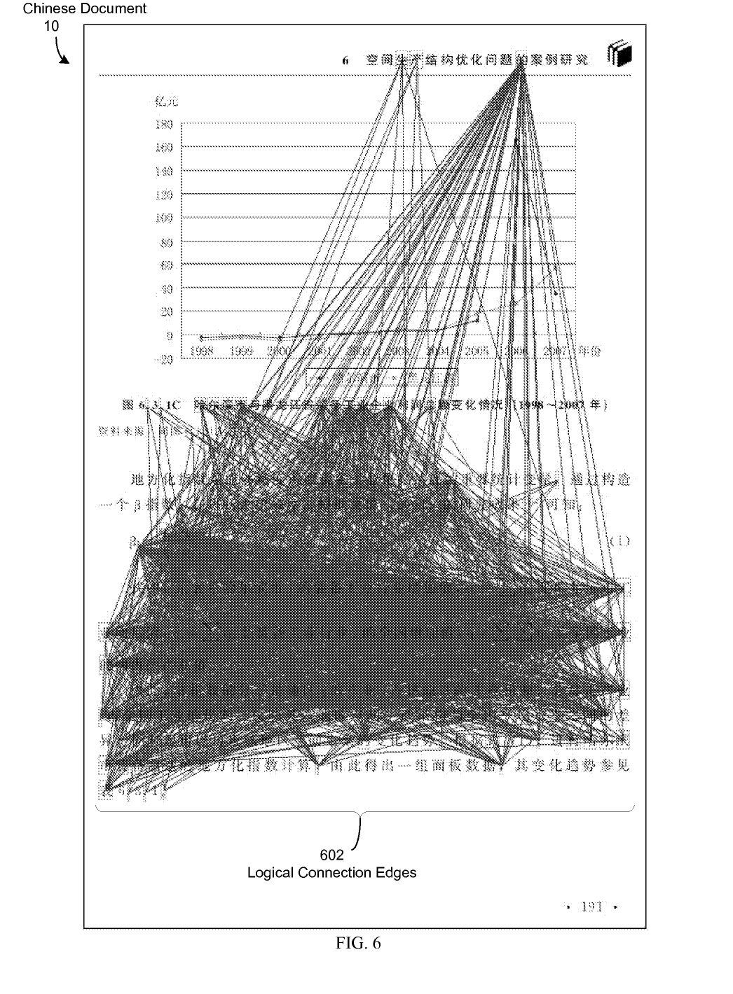

In this step, logical connection edges are generated, as illustrated in FIG. 6. As seen from FIG. 6, the character basic elements involved in the analysis are only a subset of all character basic elements on the page, and are distributed in different positions on the page; and there are a large number of initial logical connection edges.

(4.3) Line forming analyzing

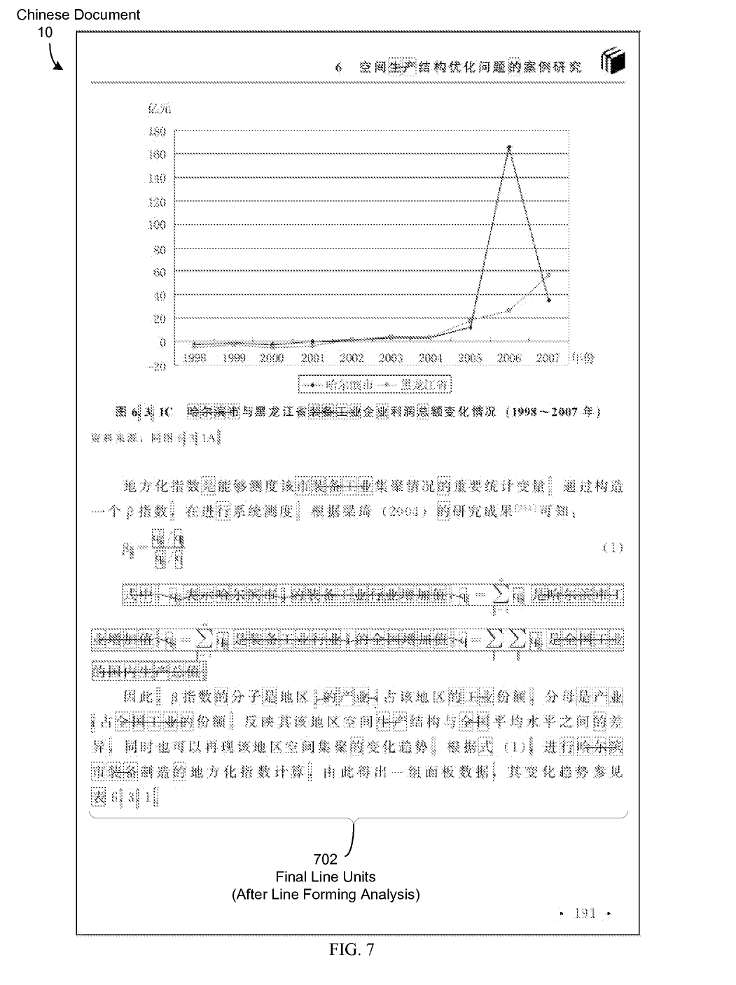

In this step, logical connection edges not satisfying the conditions are filtered out, multi-level cluster-based line forming is performed by using logical connection edges that are connected at the head and tail, invalid lines are detected and filtered out, thereby implementing the line forming analysis, as illustrated in FIG. 7. As seen from FIG. 7, after the line forming analysis, natural lines on the page are relatively obviously presented in a result set of the final line units.

(4.4) Paragraph forming analyzing

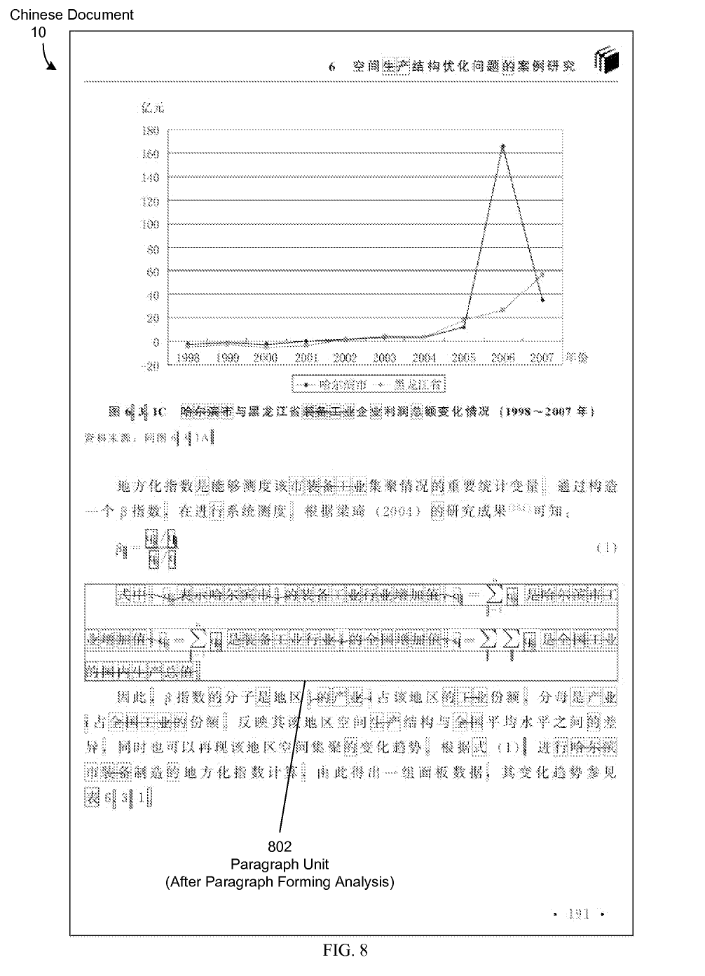

After the line forming analyzing, the paragraph forming analysis is performed, wherein final line units satisfying paragraph combination conditions are clustered and combined, to acquire all candidate paragraph units, as illustrated in FIG. 8.

(4.5) Paragraph result filtering

In this step, a matching degree of an analysis character string in a candidate paragraph unit with a logical paragraph character string is calculated by using the flexible matching algorithm in Chinese strings, results of the accurate matching and non-accurate matching that satisfying the requirements are acquired, and an optimal matching result is selected as the target paragraph and the possibly unmatched character basic elements in the target paragraph are removed.

(4.6) Collecting basic elements with respect to dynamic area objects

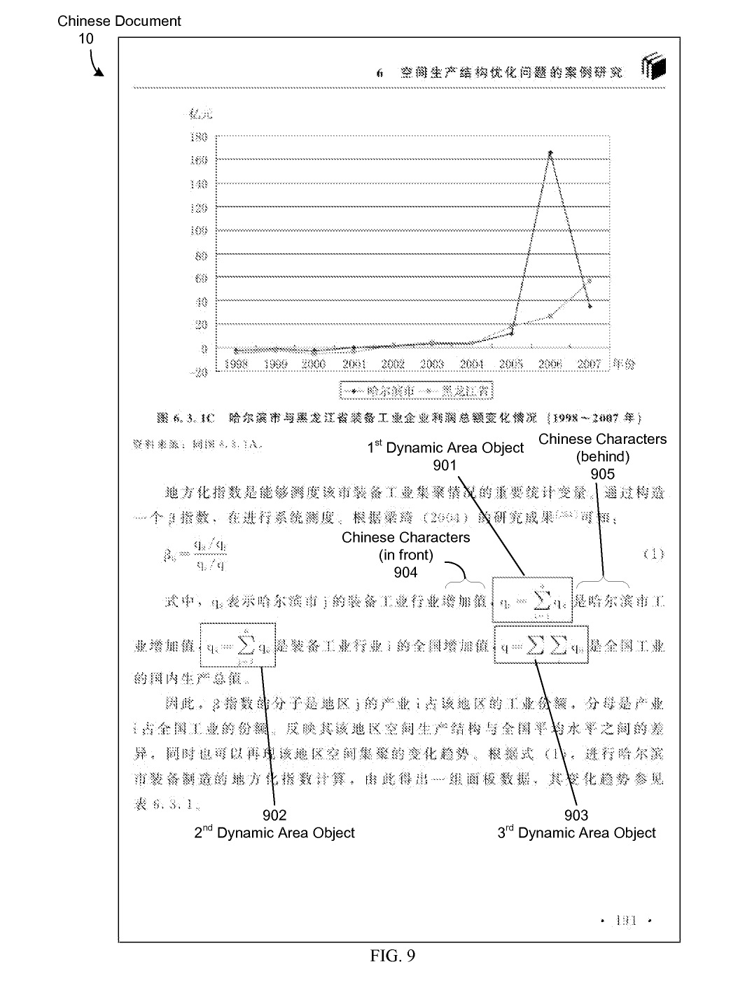

After the analysis and matching of the character basic elements in the logical paragraphs, collection areas with respect to three dynamic area objects are estimated based on experience according to the logical relationship between characters and dynamic area objects in the logical paragraphs; for example, the first dynamic area object may be estimated according to layout positions of “ [symbol] (added value)” and “ [symbol] (is Harbin)” that are in front of and behind the first dynamic area object, as illustrated in FIG. 9. For example, in known logical paragraph information, it may be known that a dynamic basic element is present between “ [symbol] [symbol] (added value)” and “ [symbol] (is Harbin)”; after the paragraph analysis and filtering, the positions of character basic elements of characters “ [symbol] (value)” and “ [symbol] (is)” on the layout may be known. In this way, it may be estimated that the collection area of the dynamic basic elements is within an area between the two basic elements. Herein the height and width may be referred to the height and width reference information of the dynamic basic element. In addition, all basic elements forming the dynamic area objects are collected from the collection area by using the same collection policy as employed with respect to the static area objects.

(4.7) Basic element removing: upon completion of the analysis of the current logical paragraph, removing the basic elements collected from the current logical paragraph from the basic element data to be analyzed on the current page.

Obviously, the above embodiments are merely exemplary ones for illustrating the present invention, but are not intended to limit the present invention. Persons of ordinary skills in the art may derive other modifications and variations based on the above embodiments. Embodiments of the present invention are not exhaustively listed herein. Such modifications and variations derived still fall within the protection scope of the present invention.

What is claimed is:

1. A layout analysis method, comprising:
acquiring, by an electronic device, logical paragraph information of a fixed-layout document, and acquiring basic element data on a current page as basic element data to be analyzed, wherein logical reference information of each logical paragraph comprises, arranged in a logical sequence, character objects, dynamic area objects and static area objects; and
collecting basic elements with respect to the static area objects, collecting basic elements with respect to the character objects based on character analysis, line forming analysis, paragraph forming analysis, and paragraph result filtering, collecting basic elements with respect to the dynamic area objects, and completing basic element collection with respect to the basic element data to be analyzed.

2. The layout analysis method according to claim 1, wherein the static area objects comprise reference information of an absolute position, a width and a height of the static area in the fixed-layout document, and the dynamic area objects only comprise reference information of a width and a height of the dynamic area.

3. The layout analysis method according to claim 1, wherein the basic element data on the current page is acquired by using a fixed-layout document engine, and comprises character basic elements, image basic elements, and graph basic elements.

4. The layout analysis method according to claim 1, wherein the process of collecting basic elements with respect to the static area objects comprises: collecting the basic elements with respect to the static area objects and removing basic element data pertaining to the static area objects from the basic element data to be analyzed.

5. The layout analysis method according to claim 3, wherein the process of collecting basic elements with respect to the character objects based on character analysis, line forming analysis, paragraph forming analysis and paragraph result filtering, the process of collecting basic elements with respect to the dynamic area objects, and the process of completing basic element collection with respect to the basic element data to be analyzed are completed by using logical paragraph analysis.

6. The layout analysis method according to claim 5, wherein during the logical paragraph analysis, an analysis sequence of each logical paragraph is determined and then each of the logical paragraphs is logically analyzed.

7. The layout analysis method according to claim 6, wherein the process of analyzing each of the logical paragraphs comprises: analyzing characters and establishing a logical connection edge, performing line forming analysis and paragraph forming analysis with respect to the logical connection edge, acquiring a target paragraph utilizing matching, and collecting basic elements of the dynamic area objects.

8. The layout analysis method according to claim 7, wherein the process of analyzing each of the logical paragraphs specifically comprises the following steps:
character analyzing: filtering all character basic elements on the current page to reserve character basic elements having an identical character code in a current logical paragraph as candidate character basic elements;
logical connection edge generating: according to a logical sequence relationship between respective two characters in the current logical paragraph, connecting, among the candidate character basic elements, all character basic elements which are respectively identical with two connected characters in the current logical paragraph, to generate a logical connection edge;
line forming analyzing: performing filtering and cluster analysis on the logical connection edges to acquire final line unit information in the logical paragraph;
paragraph forming analyzing: performing cluster analysis on all final line units according to a layout physical position relationship and a matching degree of line logical text character strings and logical text character strings in a target logical paragraph, combining final line units clustered into the same category, and performing layout analysis and sequencing thereon to generate a paragraph unit;
paragraph result filtering: performing accurate matching and non-accurate matching for all candidate paragraph units acquired by analysis and for the target logical paragraph to acquire a target paragraph unit;
collecting basic elements with respect to the dynamic area objects: with respect to each of the dynamic area objects in the logical paragraph, extracting character basic elements before and after the dynamic area object from the target paragraph unit, estimating a collection area having an absolute position according to a normal layout rule and dynamic area object width and height information within a blank area between bounding boxes of the character basic elements before and after the dynamic area object, and collecting the basic elements constituting the dynamic area object in the collection area; and
basic element removing: upon completion of the analysis of the current logical paragraph, removing the basic elements collected from the current logical paragraph from the basic element data to be analyzed on the current page, and analyzing the next logical paragraph according to the analysis sequence of the logical paragraphs.

9. The layout analysis method according to claim 6, wherein the analysis sequence of the logical paragraphs is determined according to criteria comprising: the number of characters in the logical paragraphs, wherein a logical paragraph having a larger number of characters has a higher priority; a cross-page type of the logical paragraphs, wherein a normal logical paragraph has a higher priority over a cross-page logical paragraph; and natural and logical order of the logical paragraphs.

10. The layout analysis method according to claim 8, wherein during the logical connection edge generating, when, among the candidate character basic elements, the character basic elements which are respectively identical with two connected characters in the current logical paragraph are all connected, the logical connection edge connects the center of a bounding box of each of the two character basic elements.

11. The layout analysis method according to claim 8, wherein information of the logical connection edge comprises a horizontal angle between the logical connection edge and a horizontal direction, a normalized length, and a font size proportion associated with the connected character basic elements.

12. The layout analysis method according to claim 8, wherein during the logical connection edge generating, when characters at two ends of the logical connection edge in the logical paragraph are spaced apart by the dynamic area objects or the static area objects, the logical connection edge is identified as a cross-area object logical connection edge.

13. The layout analysis method according to claim 8, wherein the line forming analysis comprises:
first-level line forming analyzing:
filtering all logical connection edges to remove logical connection edges passing through bounding boxes of other character basic elements in the page;
filtering remaining logical connection edges for the second time, comparing horizontal angles, normalized length of the remaining logical connection edges with thresholds, retaining logical connection edges satisfying threshold conditions, and deleting the logical connection edges not satisfying the threshold conditions;
clustering all retained logical connection edges to arrange logical connection edges having the same head or tail character basic elements into one category;
performing normal line character sequence analysis on all character basic elements connected by the logical connection edges in one category to determine a logical sequence of all the character basic elements, and acquiring a first-level line unit; and
generating a first-level line unit with respect to each of the character basic elements that are not connected by any logical connection edge;
second-level line forming analyzing:
finding all logical connection edges connecting the first-level line units, wherein the connected logical connection edge connects a tail character basic element of one first-level line unit and a head character basic element of another first-level line unit;
filtering all found logical connection edges to remove logical connection edges passing through bounding boxes of other character basic elements in the page, and retaining cross-area object logical connection edges;
clustering all retained logical connection edges;
combining all first-level line units connected by the logical connection edges clustered into one category, to acquire a second-level line unit; and
generating a second-level line unit with respect to each of the first-level line units that are not connected by any logical connection edge;
second-level line combining:
performing cluster analysis on all second-level line units again;
combining all second-level line units clustered into one category to generate a final line unit; and
generating a final line unit for each of uncombined second-level units; and
removing of invalid lines:
checking whether a Chinese character exists in a neighborhood of before and after positions or top and bottom positions of a bounding box of each of the final line units, and if a Chinese character exists, removing the line unit.

14. The layout analysis method according to claim 13, wherein during filtering the remaining logical connection edges for the second time in the first-level line forming analyzing, a cross-area object logical connection edge is retained when a normalized length of the cross-area object logical connection edge is close to a width or a height of an area normalization object.

15. The layout analysis method according to claim 13, wherein during the second-level line forming analyzing, all the retained logical connection edges are clustered based on the following criteria;
whether two logical connection edges connect the same first-level line unit; and
whether a perpendicular overlap degree or a horizontal overlap degree of bounding boxes of two connected first-level line units is larger than an empirical threshold, and
whether a matching degree of a combined character string of two neighboring first-level line units with a logical paragraph character string is larger than an empirical threshold, wherein the matching degree is calculated by using a flexible matching algorithm in Chinese strings.

16. The layout analysis method according to claim 13, wherein in the second-level line combining during the line forming analyzing, all the retained second-level line units are clustered again based on the following criteria:
whether a perpendicular overlap degree or a horizontal overlap degree of bounding boxes of two second-level line units is larger than an empirical threshold;
whether horizontal spacing or horizontal spacing between bounding boxes of two second-level line units is larger than 0;
whether font or font size difference used by two second-level line units satisfies requirements; and
whether a matching degree of a combined character string of two neighboring second-level line units with a logical paragraph character string is larger than a threshold, wherein the matching degree is calculated by using the flexible matching algorithm in Chinese strings.

17. The layout analysis method according to claim 8, wherein during the paragraph forming analyzing, the cluster analysis is implemented based on the following criteria:
whether a distance between text lines falls within a threshold range, and is spaced apart by an image basic element;
whether a width difference between upper and lower lines or between before and after lines as well as border alignment of line head and tail satisfy a threshold requirement with respect to a typical fixed-layout;
with respect to text lines satisfying the threshold requirement, whether a matching degree of a combined character string of two final line units with a logical paragraph character string satisfies a requirement is detected by using a flexible threshold; and
with respect to text lines not satisfying the threshold requirement, whether a matching degree of a combined character string of two final line units with a logical paragraph character string satisfies a requirement is detected by using a rigorous threshold.

18. The layout analysis method according to claim 8, wherein the paragraph result filtering comprises:
performing, according to a sequence, accurate matching and non-accurate matching for all paragraph units and the logical paragraphs, and returning a first matching result, wherein the accurate matching and the non-accurate matching are as follows:
accurate matching: with respect to a normal paragraph, a paragraph unit analysis character string needs to accurately match a logical paragraph character string; with respect to a cross-page paragraph, the paragraph unit analysis character string needs to accurately match a sub-string of the logical paragraph character string, and a bounding box of a paragraph unit is at a start or end physical position on the layout;
non-accurate matching: with respect to a normal paragraph, a matching degree, calculated by using the flexible matching algorithm in Chinese strings, of the paragraph unit analysis character string with the logical paragraph character string is larger than an empirical threshold; with respect to a cross-page paragraph, a matching degree, calculated by using the flexible matching algorithm in Chinese strings, of the paragraph unit analysis character string with a sub-string of the logical paragraph character string is larger than an empirical threshold, and a bounding box of a paragraph unit is at a start or end physical position on the layout;
using a matched paragraph unit returned after the accurate matching or the non-accurate matching as the target paragraph unit, wherein if matched paragraph units are returned after both the accurate matching and the non-accurate matching, when a length of an analysis character string of the matched paragraph unit returned after the non-accurate matching is larger than a length of an analysis character string of the matched paragraph unit returned after the accurate matching, and the difference exceeds an empirical threshold, using the matched paragraph unit returned after the non-accurate matching as the target paragraph unit, and otherwise, using the matched paragraph unit returned after the accurate matching as the target paragraph unit; and
performing character matching for the target paragraph unit and the logical paragraph by using the flexible matching algorithm in Chinese strings, and removing unmatched character basic elements in the target paragraph.

19. The layout analysis method according to claim 1, wherein the collecting basic elements with respect to the static area objects comprises: image collection, table collection, graph collection, formula collection, and an image collection policy, a table collection policy, a graph collection policy, and a formula collection policy are employed therefor respectively.

20. A layout analysis system, comprising:
an acquiring unit, configured to: acquire logical paragraph information of a fixed-layout document, and acquire basic element data on a current page as basic element data to be analyzed, wherein logical reference information of each logical paragraph comprises, arranged in a logical sequence, character objects, dynamic area objects and static area objects; and
a collecting unit, configured to: collect basic elements with respect to the static area objects; collect basic elements with respect to the character objects based on character analysis, line forming analysis, paragraph forming analysis and paragraph result filtering; collect basic elements with respect to the dynamic area objects; and complete basic element collection with respect to the basic element data to be analyzed.
